(19) United States
(12) Patent Application Publication
(10) Pub. No.: US 2015/0125772 A1
(43) Pub. Date: May 7, 2015

(54) FUEL CELL SYSTEM

(71) Applicants: Masaaki Matsusue, Mishima-shi (JP); Kotaro Ikeda, Susono-shi (JP); Yumi Inoue, Numazu-shi (JP)

(72) Inventors: Masaaki Matsusue, Mishima-shi (JP); Kotaro Ikeda, Susono-shi (JP); Yumi Inoue, Numazu-shi (JP)

(73) Assignee: TOYOTA JIDOSHA KABUSHIKI KAISHA, Toyota-shi (JP)

(21) Appl. No.: 14/382,050

(22) PCT Filed: Mar. 1, 2012
(86) PCT No.: PCT/JP2012/055194

§ 371 Date: Jan. 21, 2015

(51) Int. Cl. H01M 8/04

(52) U.S. Cl. CPC H01M 8/04611; H01M 8/04873; H01M 2008/1095
USPC 429/432

(57) ABSTRACT

A fuel cell system according to the present invention comprises: a fuel cell including a membrane-electrode assembly in which electrodes, each having a catalyst layer, are arranged on both surfaces of a polymer electrolyte membrane; a power storage apparatus connected to a load in parallel with the fuel cell; and a control apparatus that performs performance recovery processing for the catalyst layer by decreasing an output voltage of the fuel cell to a predetermined voltage, wherein an intermittent operation in which a power generation command value for the fuel cell is set to zero and a power supply to the load is covered by power supplied from the power storage apparatus is allowed to be performed if certain conditions for performing the intermittent operation are met, and the performance recovery processing is performed during the intermittent operation, and wherein, if the performance recovery processing is necessary and if a remaining power in the power storage apparatus is equal to or lower than a predetermined amount, the control apparatus delays a timing of performing the intermittent operation and charges the power storage apparatus until the remaining power exceeds the predetermined amount.

### TECHNICAL FIELD

The present invention relates to a fuel cell system having a function of activating a catalyst.

### BACKGROUND ART

A fuel cell stack is a power generation system which oxidizes a fuel through an electrochemical process to thereby directly convert energy released due to such oxidization reaction into electric energy. Such fuel cell stack has a membrane-electrode assembly in which a polymer electrolyte membrane, which selectively transports hydrogen ions, is sandwiched by a pair of electrodes made of porous materials. Each of the pair of electrodes includes: a catalyst layer that contains, as a main ingredient, carbon powder supporting a platinum-based metal catalyst and contacts with the polymer electrolyte membrane; and a gas diffusion layer formed on a surface of the catalyst layer, the gas diffusion layer having both air permeability and electronic conductivity.

In fuel cell systems of this type, when a cell continues to be operated within an operation zone where the cell voltage reaches an oxidation voltage (about 0.7 V to 1.0 V), an oxide film may be formed on a surface of the platinum catalyst in the catalyst layer and reduce an effective area of the platinum catalyst, which may cause degradation of output characteristics. In view of these circumstances, Patent Document 1 includes descriptions regarding processing in which, if the electric power requested to be generated by the fuel cell is less than a predetermined value, the supply of air (oxidant gas) to the fuel cell stack is stopped and the output voltage of the fuel cell stack is forcibly decreased by a DC/DC converter so that the cell voltage is lowered to a reduction voltage (e.g., 0.6 V or lower) to thereby remove an oxide film from the surface of the platinum catalyst and recover the performance of the catalyst layer (such processing will hereinafter be referred to as “refresh processing”).

Patent Document 1 also describes, with regard to a fuel cell vehicle which uses the fuel cell system as an in-vehicle power supply, prohibiting the refresh processing if the fuel cell vehicle is traveling at a speed equal to or greater than a predetermined value.

### PRIOR ART REFERENCE

### Patent Document

Patent Document 1: JP2008-192468 A

### SUMMARY OF THE INVENTION

### Problem to be Solved by the Invention

During the refresh processing, responsiveness to an output increase request being made to the fuel cell, in particular, responsiveness to a high-load request, may be significantly degraded because the cell voltage becomes lower in the refresh processing than in a normal load operation. For example, in the case of a fuel cell vehicle, if the cell voltage decreases due to the refresh processing, it may be impossible to obtain an output which can follow the accelerator response at the time of a high-load request and this may lead to a significant degradation in drivability (controllability).

One way to suppress such degradation of responsiveness is to perform the refresh processing during an intermittent operation. Intermittent operation is an operation in a fuel cell system having both a fuel cell and a battery as a power supply, and when certain conditions for such intermittent operation are met, for example, when an electric power required by the load is equal to or lower than a predetermined value, a power generation command value for the fuel cell is set to zero and electric power to be supplied to a load is covered by electric power supplied from the battery.

However, if a large amount of oxide film is formed on the catalyst layer so that the refresh processing should be performed for a sufficient length of time (refresh time period), but if there is not enough remaining power in the battery, the amount of power that can be supplied from the battery to a drive motor is limited and, as a result, drivability may worsen. In addition, if the amount and properties of the oxide film are inaccurately presumed, it may not be possible to obtain sufficient effects from the refresh processing.

It has been recognized that two types of oxide film—a film which can be removed by decreasing the output voltage of the fuel cell stack to a reduction voltage, as described in Patent Document 1 (hereinafter referred to as a “first reduction voltage”) (such film will hereinafter be referred to as a “type-I oxide film”), and a film which can be removed only after decreasing the output voltage to a second reduction voltage, which is lower than the first reduction voltage (such film will hereinafter be referred to as a “type-II oxide film”)—may be present in a mixed state in a single oxide film.

The refresh processing described in Patent Document 1 assumes only a single stage of voltage for a reduction voltage enabling the removal of the oxide film (first reduction voltage). Thus, even if it is possible to remove a typed oxide film by decreasing the output voltage of the fuel cell stack to such assumed first reduction voltage for a certain period of time, it is still impossible to remove a type-II oxide film. Thus, the performance of the catalyst layer may not necessarily be sufficiently recovered.

In view of the above, an object of the present invention is to propose a fuel cell system which can suppress the degradation of responsiveness during or after the processing for recovering the performance of a catalyst layer in the fuel cell.

### Means for Solving the Problem

In order to achieve the above object, a fuel cell system according to the present invention comprises: a fuel cell including a membrane-electrode assembly in which electrodes, each having a catalyst layer, are arranged on both surfaces of a polymer electrolyte membrane; a power storage apparatus connected to a load in parallel with the fuel cell; and a control apparatus that performs performance recovery processing for the catalyst layer by decreasing an output voltage of the fuel cell to a predetermined voltage, wherein an intermittent operation in which a power generation command value for the fuel cell is set to zero and a power supply to the load is covered by power supplied from the power storage apparatus is allowed to be performed if certain conditions for performing the intermittent operation are met, and the performance recovery processing is performed during the intermittent operation, and wherein, if the performance recovery processing is necessary and if a remaining power in the power storage apparatus is equal to or lower than a predetermined amount, the control apparatus delays a timing of performing the intermittent operation and charges the power storage apparatus until the remaining power exceeds the predetermined amount.

According to the above configuration, in a fuel cell system that performs performance recovery processing for a catalyst layer during an intermittent operation, if the performance recovery processing is deemed to be necessary and if the remaining power in the power storage apparatus is equal to or lower than a predetermined amount, priority is placed on charging of the power storage apparatus over the performance recovery processing. As a result, a certain remaining power can be ensured in the power storage apparatus during or after the time in which the performance recovery processing is being performed after the fuel cell system shifted to the intermittent operation, and this can minimize the influence on responsiveness.

In the above configuration, the control apparatus may be configured to predict the timing of an output increase request being made to the fuel cell and determine the content of the performance recovery processing based on a result of such prediction. For example, if the fuel cell system is installed in a fuel cell vehicle as an in-vehicle power supply, the control apparatus may predict the timing of an output increase request being made to the fuel cell based on the travelling state of the vehicle.

According to the above configuration, when necessary, the performance recovery processing for the catalyst layer is not performed in an equal manner, but instead, the amount of oxide film to be removed from the entire oxide film formed on the catalyst layer can be adjusted according to the predicted timing of an output increase request. Accordingly, it is possible to achieve a balance between the minimization of the influence on responsiveness (drivability in the case of an in-vehicle fuel cell system) and the maximization of the performance recovery of the catalyst layer.

In the above configuration, if a first oxide film which is able to be removed by decreasing the output voltage of the fuel cell to a first film removal voltage and a second oxide film which is able to be removed only after decreasing the output voltage of the fuel cell to a second film removal voltage, which is lower than the first film removal voltage, are present in a mixed state in an oxide film formed on the catalyst layer during power generation by the fuel cell, the control apparatus may change the predetermined voltage to which the output voltage is to be decreased according to the result of the prediction when the performance recovery processing is necessary.

In the above configuration, the performance recovery processing can be performed in such a manner that, if it is predicted that an output increase request will soon be made to the fuel cell, first priority will be placed on minimizing the influence on responsiveness to such output increase request and the output voltage of the fuel cell will thus be decreased only to the first film removal voltage; whereas, if it is predicted that an output increase request will not soon be made to the fuel cell, first priority will be placed on maximizing the performance recovery of the catalyst layer, and the output voltage of the fuel cell will be thus decreased to the second film removal voltage.

In the above configuration, if a first oxide film which is able to be removed by decreasing the output voltage of the fuel cell to a first film removal voltage and a second oxide film which is able to be removed only after decreasing the output voltage of the fuel cell to a second film removal voltage, which is lower than the first film removal voltage, are present in a mixed state in an oxide film formed on the catalyst layer during power generation by the fuel cell, the control apparatus may change the time period for performing the performance recovery processing according to the result of the prediction when the performance recovery processing is necessary.

In the above configuration, if an output increase request to the fuel cell is predicted to be made soon, the performance recovery processing is allowed to be performed for a short period of time so as to place first priority on minimizing the influence on responsiveness to such output increase request. On the other hand, if an output increase request to the fuel cell is predicted to not be made so soon, the performance recovery processing is allowed to be performed for a long period of time, in order to place first priority on maximizing the performance recovery of the catalyst layer.

### Effect of the Invention

The present invention can provide a fuel cell system capable of suppressing the degradation of responsiveness during or after the processing for recovering the performance of a catalyst layer in the fuel cell.

### BRIEF DESCRIPTION OF THE DRAWINGS

FIG. 1 is a configuration diagram showing a fuel cell system according to an embodiment of the present invention.

FIG. 2 is an exploded perspective view showing a cell constituting a fuel cell stack.

FIG. 3 is a timing chart showing one example of operation control of a fuel cell system.

FIG. 4 is a flowchart showing the procedure for performing refresh processing when, as one condition, the remaining power in a battery exceeds a predetermined threshold.

FIG. 5 is a view showing the relationship between the output current of a fuel cell and the content ratio of a type-II oxide film in an oxide film.

FIG. 6 is a view showing how the respective proportions of a type-I oxide film, a type-II oxide film and a type-III oxide film in an oxide film formed on a catalyst layer vary over time when the output voltage of a fuel cell stack is held at a constant value.

FIG. 7 is a view showing how the respective proportions of a type-I oxide film and a type-II oxide film in an oxide film formed on a catalyst layer vary in accordance with an increase in the number of times the output voltage of a fuel cell stack crosses a predetermined boundary voltage during its increase and decrease.

FIG. 8 is a timing chart showing another example of operation control of a fuel cell system.

FIG. 9 is a timing chart showing a further example of operation control of a fuel cell system.

### DESCRIPTION OF REFERENCE NUMERALS

11 Fuel cell system

12 Fuel cell

24a Catalyst layer

25 Membrane-electrode assembly

52 Battery (power storage apparatus)

60 Controller (control apparatus)

### MODE FOR CARRYING OUT THE INVENTION

Embodiments of the present invention will be described below with reference to the attached drawings. The same apparatuses are given the same reference numeral and any repetitive descriptions will be omitted.

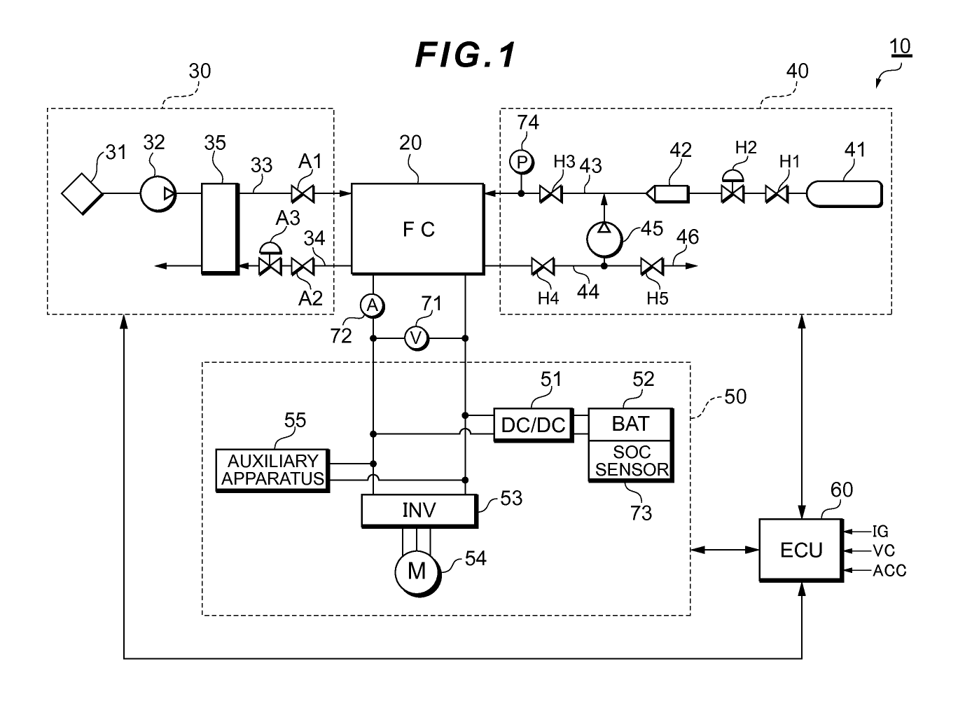

FIG. 1 illustrates the system configuration of a fuel cell system 10 according to an embodiment of the present invention.

The fuel cell system 10 serves as an in-vehicle power supply system that is installed in a fuel cell vehicle and includes: a fuel cell stack 20 which receives supply of reactant gases (a fuel gas and an oxidant gas) and generates electric power; an oxidant gas supply system 30 for supplying the air serving as the oxidant gas to the fuel cell stack 20; a fuel gas supply system 40 for supplying a hydrogen gas serving as the fuel gas to the fuel cell stack 20; a power system 50 for controlling charge and discharge of electric power; and a controller 60 which controls the entire system.

The fuel cell stack 20 is a solid polymer electrolyte-type cell stack in which a plurality of cells are stacked in series. In the fuel cell stack 20, the oxidation reaction in formula (1) occurs in an anode and the reduction reaction in formula (2) occurs in a cathode. The electrogenic reaction in formula (3) occurs in the fuel cell stack 20 as a whole.

H₂→2H⁺+2e⁻ (1)

(½)O₂+2H⁺+2e⁻→H₂O (2)

H₂+(½)O₂→H₂O (3)

The fuel cell stack 20 is provided with: a voltage sensor 71 for detecting an output voltage of the fuel cell stack 20 (FC voltage); and a current sensor 72 for detecting an output current of the fuel cell stack 20 (FC current).

The oxidant gas supply system 30 includes: an oxidant gas path 33 in which the oxidant gas to be supplied to the cathode in the fuel cell stack 20 flows; and an oxidant off-gas path 34 in which an oxidant off-gas discharged from the fuel cell stack 20 flows. The oxidant gas path 33 is provided with: an air compressor 32 which introduces the oxidant gas from the atmosphere via a filter 31; a humidifier 35 which humidifies the oxidant gas compressed by the air compressor 32; and a cutoff valve A1 for cutting off the supply of the oxidant gas to the fuel cell stack 20.

The oxidant off-gas path 34 is provided with: a cutoff valve A2 for cutting off the discharge of the oxidant off-gas from the fuel cell stack 20; a backpressure regulating valve A3 for regulating the supply pressure of the oxidant gas; and a humidifier 35 for exchanging moisture between the oxidant gas (dry gas) and the oxidant off-gas (wet gas).

The fuel gas supply system 40 includes: a fuel gas supply source 41; a fuel gas path 43 in which the fuel gas to be supplied from the fuel gas supply source 41 to the anode in the fuel cell stack 20 flows; a circulation path 44 for returning the fuel off-gas discharged from the fuel cell stack 20 to the fuel gas path 43; a circulation pump 45 which pumps the fuel off-gas in the circulation path 44 to send it to the fuel gas path 43; and an exhaust/drain path 46 which branches from the circulation path 44.

The fuel gas supply source 41 is constituted from, for example, a high-pressure hydrogen tank, a hydrogen absorbing alloy or similar and stores a hydrogen gas at a high pressure (e.g., 35 MPa to 70 MPa). When opening a cutoff valve H1, the fuel gas flows from the fuel gas supply source 41 toward the fuel gas path 43. The pressure of the fuel gas is reduced to, for example, about 200 kPa by, for example, a regulator H2 and an injector 42, and then the fuel gas is supplied to the fuel cell stack 20.

The circulation path 44 is connected to a cutoff valve H4 for cutting off the discharge of the fuel off-gas from the fuel cell stack 20 and the exhaust/drain path 46 branching from the circulation path 44. The exhaust/drain path 46 is provided with an exhaust/drain valve H5. The exhaust/drain valve H5 is actuated by a command from the controller 60 so as to discharge water, as well as the fuel off-gas containing impurities within the circulation path 44, toward the outside.

The fuel off-gas discharged from the exhaust/drain valve H5 is mixed with the oxidant off-gas flowing through the oxidant off-gas path 34 and diluted by a diluter (not shown). The circulation pump 45 is driven by a motor so as to circulate the fuel off-gas within the circulation system and supply it to the fuel cell stack 20.

The power system 50 includes a DC/DC converter 51, a battery (power storage apparatus) 52, a traction inverter 53, a traction motor 54 and auxiliary apparatuses 55. The DC/DC converter 51 has: a function of increasing a direct-current voltage supplied from the battery 52 and outputting the resulting voltage to the traction inverter 53; and a function of decreasing the voltage of direct-current power generated by the fuel cell stack 20 or the voltage of regenerative power collected by the traction motor 54 as a result of regenerative braking, in order to charge the battery 52 with the resulting power.

The battery 52 functions as: a storage source for excess electric power; a storage source for regenerative energy during a regenerative braking operation; or an energy buffer provided for a load change resulting from acceleration or deceleration of a fuel cell vehicle. Suitable examples of the battery 52 may include a secondary cell, such as a nickel-cadmium battery, a nickel-hydrogen battery and a lithium battery. An SOC (State of Charge) sensor is attached to the battery 52 to detect the state of charge, being the remaining power, of the battery 52.

The traction inverter 53 may be, for example, a PWM inverter driven by pulse width modulation and the traction inverter 53 converts a direct-current voltage output from the fuel cell stack 20 or the battery 52 to a three-phase alternating current voltage in accordance with a control command provided by the controller 60 and controls a rotation torque of the traction motor 54. The traction motor 54 may be, for example, a three-phase alternating current motor which constitutes a power source of the fuel cell vehicle.

The auxiliary apparatuses 55 collectively refer to motors provided in respective parts of the fuel cell system 10 (e.g., power sources for the pumps), inverters for driving these motors, various types of in-vehicle auxiliary apparatuses (e.g., an air compressor, injector, cooling-water circulation pump, radiator, etc.).

The controller 60 is a computer system which includes a CPU, a ROM, a RAM, input/output interfaces and the like, wherein the controller 60 controls components of the fuel cell system 10. For example, when receiving a start signal IG output from an ignition switch, the controller 60 starts the operation of the fuel cell system 10 and obtains electric power required from the entire system based on an accelerator opening degree signal ACC output from an acceleration sensor and a vehicle speed signal VC output from a vehicle speed sensor. The electric power required from the entire system is the sum of the amount of electric power for the vehicle travel and the amount of electric power for the auxiliary apparatuses.

The electric power for the auxiliary apparatuses includes electric power consumed by the in-vehicle auxiliary apparatuses (the humidifier, air compressor, hydrogen pump, cooling-water circulation pump, etc.), electric power consumed by apparatuses which are required for the travel of the vehicle (a transmission, wheel control apparatus, steering gear, suspension, etc.), electric power consumed by apparatuses provided inside the passenger compartment (an air conditioner, lighting equipment, audio system, etc.), and the like.

The controller 60 determines the distribution ratio of the electrical power output from the fuel cell stack 20 and the electric power output from the battery 52 and controls the oxidant gas supply system 30 and the fuel gas supply system 40 so that the amount of electric power generated by the fuel cell stack 20 matches with a target electric power. The controller 60 further controls the DC/DC converter 51 so as to regulate the output voltage of the fuel cell stack 20 and thereby control the operating point (the output voltage and the output current) of the fuel cell stack 20.

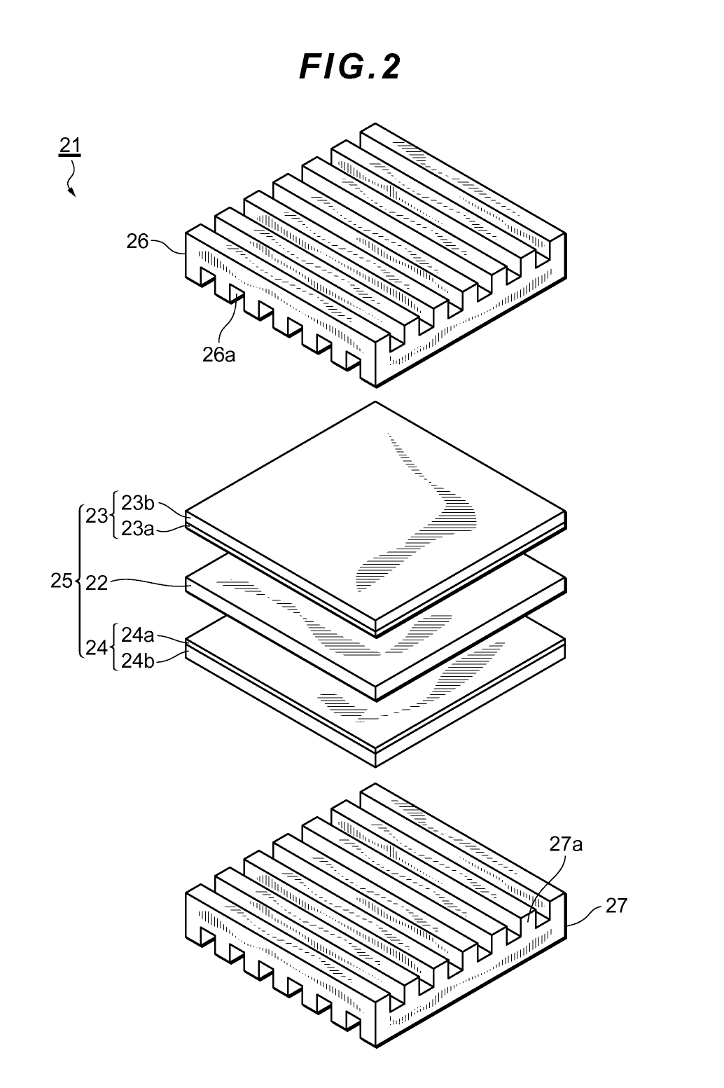

FIG. 2 is an exploded perspective view showing a cell 21 constituting the fuel cell stack 20.

The cell 21 includes a polymer electrolyte membrane 22, an anode 23, a cathode 24 and separators 26 and 27. The anode 23 and the cathode 24 are diffusion electrodes having a sandwich structure in which such electrodes sandwich the polymer electrolyte membrane 22 from both sides thereof.

The separators 26 and 27 are made of a gas impermeable conductive member and they further sandwich the above sandwich structure from both sides thereof and form a fuel gas flow path and an oxidant gas flow path between the separators and the anode 23 and cathode 24, respectively. The separator 26 is provided with ribs 26a having a recessed shape in cross section.

By allowing the ribs 26a to abut onto the anode 23, the openings of the ribs 26a are closed so as to form the fuel gas flow path. The separator 27 is provided with ribs 27a having a recessed shape in cross section. By allowing the ribs 27a to abut onto the cathode 24, the openings of the ribs 27a are closed so as to form the oxidant gas flow path.

The anode 23 includes: a catalyst layer 23a which contains, as a main ingredient, carbon powder that supports a platinum-based metal catalyst (Pt, Pt—Fe, Pt—Cr, Pt—Ni, Pt—Ru, etc.) and contacts with the polymer electrolyte membrane 22; and a gas diffusion layer 23b formed on a surface of the catalyst layer 23a and having both permeability and electronic conductivity. The cathode 24 also includes a catalyst layer 24a and a gas diffusion layer 24b in the same way.

More specifically, the catalyst layers 23a and 24a are formed by dispersing the carbon powder, which is supporting platinum or an alloy consisting of platinum and other metal(s), into a suitable organic solvent, adding thereto an appropriate quantity of an electrolyte solution to turn it into a paste, and screen-printing the paste onto the polymer electrolyte membrane 22. The gas diffusion layers 23b and 24b may be formed of carbon cloth, carbon paper or carbon felt which is woven by carbon fiber yarn.

The polymer electrolyte membrane 22 is a proton-conducting ion-exchange membrane made of a solid polymer material (e.g., fluorinated resin) and such polymer electrolyte membrane 22 exhibits a preferable electrical conductivity in wet conditions. The polymer electrolyte membrane 22, the anode 23, and the cathode 24 form a membrane-electrode assembly 25.

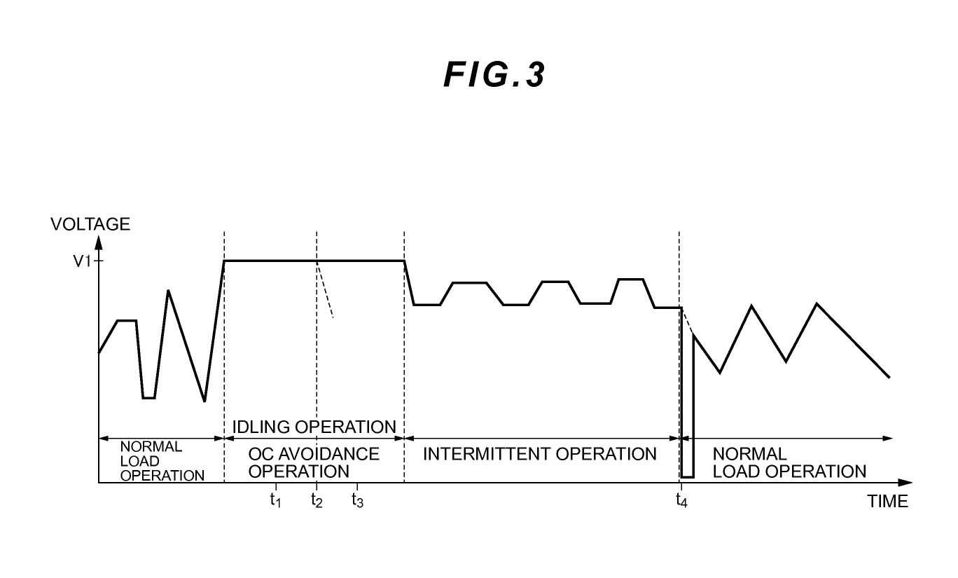

FIG. 3 is a timing chart showing operation control of the fuel cell system 10.

The fuel cell system 10 is configured so as to improve its power generation efficiency by switching the operation modes of the fuel cell stack 20 in accordance with the operation load.

For example, in a high load zone with a high power generation efficiency (an operation zone where the amount of power requested to be generated is equal to or higher than a predetermined value), the fuel cell system 10 performs a normal load operation in which the operation is controlled by calculating a power generation command value for the fuel cell stack 20 based on the degree of opening of an accelerator and the vehicle speed, and electric power required for travel of the vehicle and electric power required for operation of the system are covered only by electric power generated by the fuel cell stack 20 or by electric power generated by the fuel cell stack 20 and electric power supplied from the battery 52.

On the other hand, in a low load zone with a low power generation efficiency (an operation zone, satisfying the condition of performing an intermittent operation, where the amount of power requested to be generated is less than a predetermined value), the fuel cell system 10 performs an intermittent operation in which the operation is controlled by setting a power generation command value for the fuel cell stack 20 to zero, and the electric power required for travel of the vehicle and the electric power required for operation of the system are covered by the electric power supplied from the battery 52. It should be noted that the cell voltage is held relatively high during the intermittent operation because drivability will deteriorate if the cell voltage is low when a high-load request (output increase request) is received during the intermittent operation.

When the vehicle is stopped, for example, immediately after the vehicle is started or while the vehicle is stopping at a red light, in other words, when the shift lever is in the P-range or N-range, or when the brake pedal is pressed and the vehicle speed is zero even though the shift lever is in the D-range, the fuel cell system 10 performs an idling operation in which it operates the fuel cell stack 20 to generate electric power at a power generation voltage required for ensuring drivability while charging the battery 52 with the generated power.

In a state where the cathode 24 is held at a high voltage, for example, during an idling operation described above, a platinum catalyst in the catalyst layer 24a may be dissolved, and thus, the fuel cell stack 20 is operated under a high-potential avoidance control (OC avoidance operation) in which the output voltage of the fuel cell stack 20 is controlled so as not to exceed an upper limit voltage V1, to thereby maintain the durability of the fuel cell stack 20. The upper limit voltage V1 is set to, for example, around 0.9 V per cell.

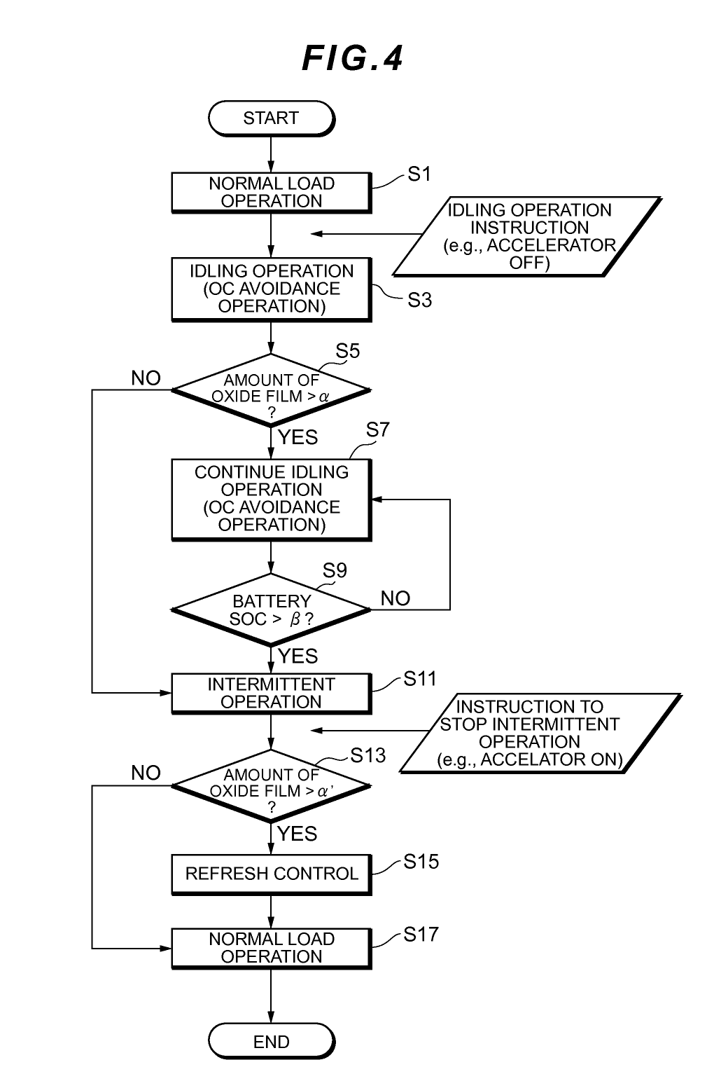

FIG. 4 is a flowchart showing the procedure for performing the refresh processing when, as one condition, the remaining power in the battery 52 exceeds a predetermined threshold. This flowchart will now be described below, by also referring to FIG. 3 as necessary.

When the controller 60 detects a signal for instructing an idling operation during a normal load operation (step S1), the controller 60 shifts the operation status of the fuel cell system 10 from the normal load operation to the idling operation (step S3). The above-described OC avoidance operation is performed during this idling operation.

Examples of the signal for instructing an idling operation include: an accelerator opening degree signal ACC output from an acceleration sensor, indicating that the accelerator opening degree is zero (i.e. the accelerator is OFF); and a braking degree signal output from a brake sensor, indicating that the degree of braking is full.

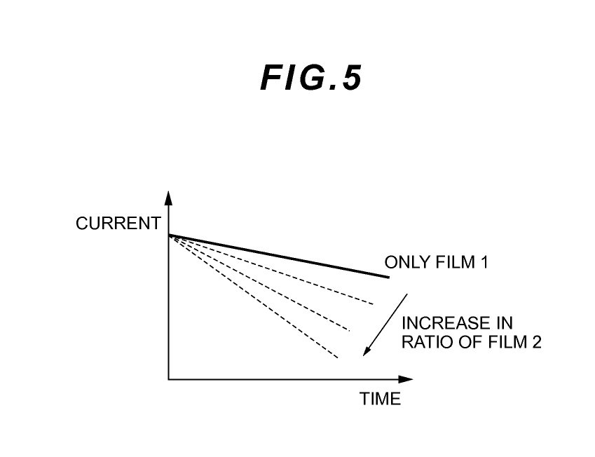

Next, the controller 60 determines whether or not the total amount of oxide film formed on the platinum catalyst surface of the catalyst layer 24a exceeds a predetermined amount α (step S5, at a timing of time t2 in FIG. 3). The total amount of oxide film is estimated by, for example, referring to the map shown in FIG. 5. The map in FIG. 5 shows the relationship among the time elapsed from the previous refresh processing (horizontal axis), a power generation current of the fuel cell stack 20 (vertical axis) and the total amount of oxide film and the breakdown thereof (solid line and broken line in FIG. 5). This map has been created based on the results of experiments and simulations and stored in a memory in the controller 60.

It is obvious from FIG. 5 that the power generation current of the fuel cell stack 20 decreases as time passes from the previous refresh processing, and that the rate of decrease of the power generation current of the fuel cell stack 20 relative to the elapsed time from the previous refreshing time, i.e., the influence on the degradation of the performance of the catalyst layer 24a, increases in accordance with the increase in the amount of a type-II oxide film (denoted as “film 2” in FIG. 5) in the entire oxide film.

This further indicates that an oxide film including a type-II oxide film would have a greater influence on the performance degradation of the catalyst layer 24a as compared to an oxide film consisting only of a type-I oxide film (denoted as “film 1” in FIG. 5), and that if the oxide film includes a type-II oxide film, the higher the content ratio of the type-II oxide film, the greater its influence will be on the performance degradation of the catalyst layer 24a.

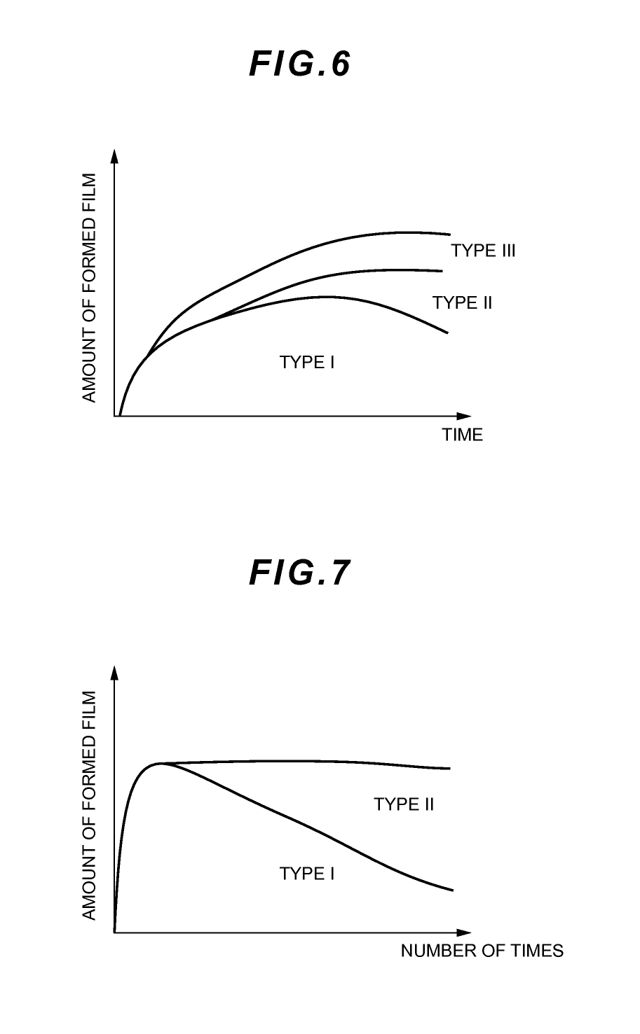

The type-I oxide film, type-II oxide film and type-Ill oxide film will now be further described. These oxide films are known as films that may be present in a mixed state in a single oxide film. Further, when the output voltage of the fuel cell stack 20 is held at a constant oxide film formation voltage (oxidation voltage), the proportions of the three types in the entire oxide film are known to gradually vary as the holding time passes, as shown, for example, in FIG. 6. Furthermore, the magnitudes of the reduction voltages of the respective oxide films satisfy the following relationship:

Type-I oxide film (e.g., 0.65 V to 0.9 V)>Type-II oxide film (e.g., 0.4 V to 0.6 V)>Type-III oxide film (e.g., 0.05 V to 0.4 V).

In addition, the respective proportions of the type-I oxide film, type-II oxide film and type-III oxide film in the entire oxide film are known to gradually vary in accordance with the increase in the number of times the output voltage of the fuel cell stack 20 crosses a predetermined boundary voltage (e.g., 0.8 V) during its increase and decrease (hereinafter referred to as the “number of cycles”), as shown, for example, in FIG. 7 (the type-III oxide film is not shown therein).

During the idling operation, the fuel cell stack 20 is operated so as to generate electric power at a constant voltage as shown in FIG. 3 and this power generation voltage is an oxidation voltage. Accordingly, an oxide film is formed on the catalyst layer 24a at that time. The controller 60 assumes a certain point in time during the idling operation to be a starting point, obtains an amount of decrease in the power generation current of the fuel cell stack 20 when a predetermined time has elapsed from the starting point, and calculates the rate of decrease of the power generation current from such amount of decrease (the gradient of each line in FIG. 5 corresponds to such rate of decrease). Then, the controller 60 applies the calculated rate of decrease of the power generation current to the map shown in FIG. 5 to thereby obtain the total amount of oxide film and the breakdown thereof (e.g., the content ratio of the type-II oxide film) in step S5 (at a timing of time t1 in FIG. 3).

If the thus-obtained total amount of oxide film exceeds the predetermined amount α (step S5: YES), the controller 60 continues the idling operation (at a timing of time t3 in FIG. 3) and charges the battery 52 with the power generated by the fuel cell stack 20 (step S7). Then, if the remaining power in the battery is equal to or lower than a predetermined amount p (e.g., 50%) (step S9: NO), the controller 60 returns to step S7 and continues the idling operation so as to continue charging the battery 52 with the power generated by the fuel cell stack 20.

On the other hand, if the remaining power in the battery (denoted as “SOC” in FIG. 4) exceeds the predetermined amount 13 (step S9: YES), the controller 60 shifts the operation status of the fuel cell system 10 from the idling operation to an intermittent operation (step S11). After that, when the controller 60 detects a signal for instructing the stop of the intermittent operation, the controller 60 determines whether or not the total amount of oxide film exceeds a predetermined amount α′ (step S13).

Since the determination in step S13 is the same as the determination in step S5, except that different thresholds, i.e., the predetermined amount α and predetermined amount α′, are used, the description of step S13 will be omitted here.

It should be noted that examples of the signal for instructing the stop of the intermittent operation include an accelerator opening degree signal ACC, which is output from an acceleration sensor, indicating that the opening degree of the accelerator is a predetermined degree or greater (i.e. the accelerator is ON).

If the total amount of oxide film exceeds the predetermined amount α′ (step S13: YES), the controller 60 performs the refresh processing (step S15, at a timing of time t4 in FIG. 3), and thereafter shifts the operation status of the fuel cell system 10 from the intermittent operation to a normal load operation (step S17). On the other hand, if the total amount of oxide film is equal to or lower than the predetermined amount α′ (step S13: NO), the controller 60 shifts the operation status of the fuel cell system 10 from the intermittent operation to a normal load operation without performing the refresh processing (step S17).

The refresh processing will now be further described.

In the fuel cell stack 20, hydrogen ions generated at the anode 23, as shown by formula (1) above, pass through the electrolyte membrane 22 and move to the cathode 24, and the hydrogen ions that have moved to the cathode 24 electrochemically react with oxygen in the oxidant gas supplied to the cathode 24 and cause a reduction reaction of oxygen, as shown by formula (2) above. Due to this, the platinum catalyst surface of the catalyst layer 24a is covered by an oxide film, which will reduce an effective area and degrade the power generation efficiency (output characteristics).

The refresh processing is processing in which the cell voltage is decreased to a reduction voltage (hereinafter also referred to as a “refresh voltage”) for a predetermined time period (hereinafter also referred to as a “refresh time period”) so as to reduce the oxide film and remove it from the catalyst surface. More specifically, the voltage of each cell, namely, the output voltage of the fuel cell stack 20 is lowered for a predetermined time period, so as to increase the output current and shift the electrochemical reaction occurring at the catalyst layer 24a from an oxidation reaction zone to a reduction reaction zone, thereby recovering the catalytic activity.

As is clear from the above description, the predetermined amount α′ used for the determination in step S13 is a threshold for determining the necessity of the refresh processing; whereas, the predetermined amount α used for the determination in step S5, which is greater than the predetermined amount α′, is a threshold for ensuring, if the remaining power in the battery 52 is equal to or lower than the predetermined amount β, a remaining power in the battery 52 which is necessary and sufficient for suppressing the degradation of drivability even when the refresh processing is performed in a manner necessary and sufficient for the performance recovery of the catalyst layer 24a.

Accordingly, if the total amount of oxide film is equal to or lower than the predetermined amount α (step S5: NO), it is not necessary to continue the idling operation to charge the battery 52 with the power generated by the fuel cell stack 20. Thus, in that case, the processes in steps S7 and S9 are skipped in the present embodiment and the operation status of the fuel cell system 10 is shifted from the idling operation to the intermittent operation (step S11).

Since the main features of the present embodiment reside in steps S5, S7 and S9 in FIG. 4, as described above, steps S5, S7 and S9 will now be further described below.

If the operation status of the fuel cell system 10 is shifted from the idling operation to the intermittent operation (step S11) without performing the processes in steps S7 and S9 in the case where the total amount of oxide film exceeds the predetermined amount α (step S5: YES), the remaining power in the battery 52 could be insufficient after the refresh processing is performed and thus cause a deterioration of drivability. More specifically, if the total amount of oxide film is large, the necessary time for the refresh processing (refresh time period) will be long and the amount of power discharged from the battery 52 will increase, and this could cause a situation in which the battery 52 does not have a sufficient amount of remaining power upon receipt of a sudden high-load request.

In the present embodiment, however, in order to avoid such situations, the remaining power in the battery 52 is always checked (step S9) when the total amount of oxide film is large (i.e., it exceeds the predetermined amount α) (step S5: YES). If the remaining power in the battery 52 is insufficient (i.e., it is equal to or lower than the predetermined amount β) (step S9: NO), the operation will not immediately be shifted to the intermittent operation (step S11) even if the total amount of oxide film has reached the value at which the refresh processing should be performed (step S5: YES), but rather, the timing of such shift will be delayed so as to continue charging the battery 52 under the idling operation status (step S7).

In other words, if the total amount of oxide film is large (i.e., it exceeds the predetermined amount α) (step S5: YES), the present embodiment places priority on ensuring the remaining power in the battery 52 over performing the refresh processing. As a result, even if the refresh processing is performed for a long refresh time period during the intermittent operation and if a high-load request occurs thereafter, sufficient remaining power will be ensured in the battery 52 and this will consequently ensure drivability.

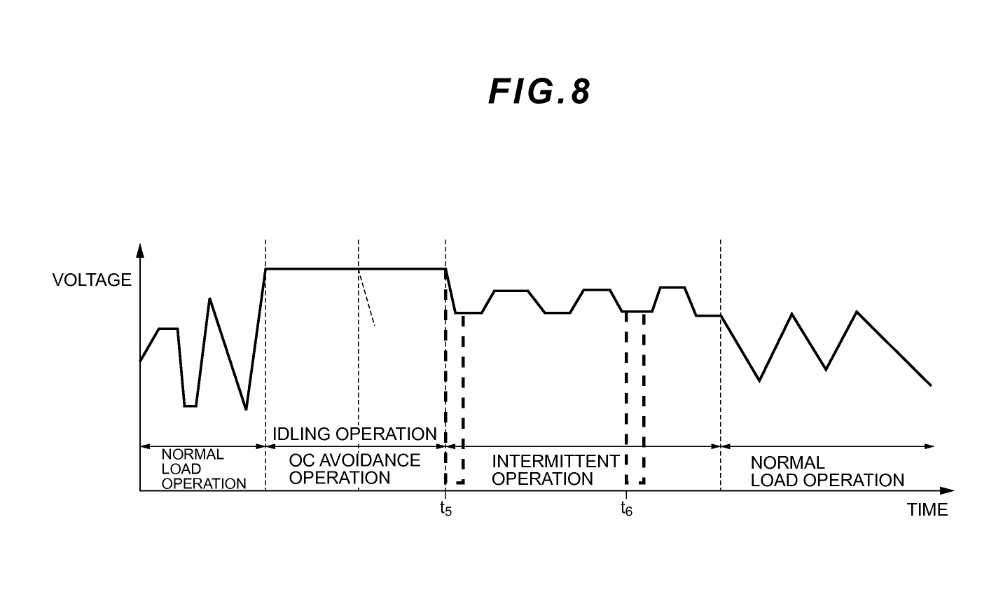

The embodiment shown in FIG. 3 describes an example in which the refresh processing is performed after the operation status of the fuel cell system 10 is shifted from the intermittent operation to the normal load operation. However, as shown, for example, in FIG. 8, the refresh processing may be performed at a timing (time t5) immediately after the operation status of the fuel cell system 10 is shifted from the idling operation to the intermittent operation, or at a certain timing (time t6) during the intermittent operation.

It should be noted that the broken line in FIG. 8 shows how the cell voltage varies when the refresh processing is performed. It should also be noted that, for convenience of explanation, an example in which the refresh processing is performed at a timing (time t5) immediately after the operation status of the fuel cell system 10 is shifted from the idling operation to the intermittent operation, and an example in which the refresh processing is performed at a certain timing (time t6) during the intermittent operation, are both illustrated in a single chart in FIG. 8.

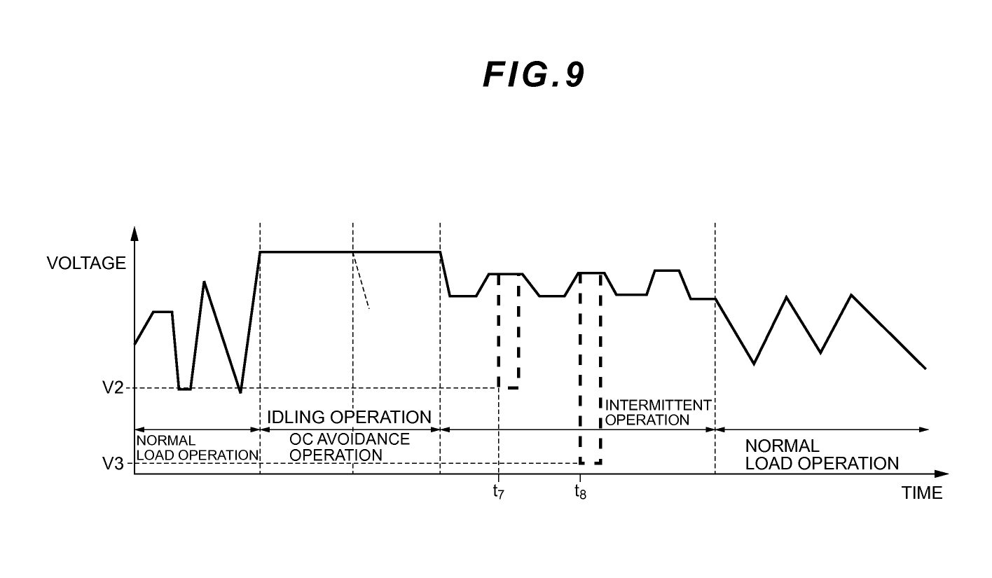

When performing the refresh processing during the intermittent operation, the refresh voltage may be changed according to the vehicle speed, as shown, for example, in FIG. 9.

The broken line in FIG. 9 shows how the cell voltage varies when the refresh processing is performed. In FIG. 9, for convenience of explanation, first refresh processing having a refresh voltage set to V2 (illustrated in FIG. 9 as being performed at a timing of time t7), and second refresh processing having a refresh voltage set to V3 which is lower than V2 (illustrated in FIG. 9 as being performed at a timing of time t8), are both illustrated in a single chart.

First Refresh Processing

If the vehicle speed detected based on the vehicle speed signal VC output from the vehicle speed sensor exceeds a predetermined value ε, in other words, if it is determined that there is the possibility that the accelerator pedal will be further pressed for acceleration (if an output increase request is predicted to occur), the refresh voltage is set to, for example, a voltage V2, which is a voltage necessary for removing the type-I oxide film, so as to suppress the decrease of the cell voltage as much as possible and to thereby ensure drivability.

Second Refresh Processing

On the other hand, if the vehicle speed detected based on the vehicle speed signal VC output from the vehicle speed sensor is equal to or lower than the predetermined value ε, in other words, if it is determined that the possibility that the accelerator pedal will be further pressed for acceleration is low (if no output increase request is predicted), it is not particularly necessary to consider ensuring drivability and the refresh voltage is thus reduced to, for example, a voltage V3, which is a voltage necessary for removing the type-II oxide film or type-III oxide film, so as to sufficiently recover the performance of the catalyst layer 24a.

Modification of Second Refresh Processing

The refresh processing with a refresh voltage reduced to the voltage V3 may be performed not only in the above-mentioned case where the vehicle speed is equal to or lower than the predetermined value ε, but also in the case where the shift lever is in any of the P-range (parking), N-range (neutral) or B-range (engine braking). This is because the cases where the shift lever is put into those ranges can be regarded as having a low possibility of acceleration (cases where no output increase request is predicted).

The above embodiment describes examples where the refresh voltage is changed according to the vehicle speed or the position of the shift lever, but a configuration of changing the refresh time period is also possible.

For example, if the vehicle speed is equal to or less than the predetermined value ε, or if the shift lever is in the P-range, N-range or B-range, the refresh time period may be set so as to be longer than in the case where the vehicle speed exceeds the predetermined value ε or in the case where the shift lever is in ranges other than the P-, N- and B-ranges, e.g., the D-range.

Each of the above-described embodiments describes an example in which the fuel cell system 10 is used as an in-vehicle power supply system but the use of the fuel cell system 10 is not limited thereto. For example, the fuel cell system 10 may be installed as a power source for moving objects (robots, ships, airplanes, etc.) other than fuel cell vehicles. Further, the fuel cell system 10 according to the above embodiments may be used as power generation equipment (stationary power generation system) for houses and buildings, etc.

What is claimed is:

1. A fuel cell system comprising:
a fuel cell including a membrane-electrode assembly in which electrodes, each having a catalyst layer, are arranged on both surfaces of a polymer electrolyte membrane;
a power storage apparatus connected to a load in parallel with the fuel cell; and
a control apparatus that performs performance recovery processing for the catalyst layer by decreasing an output voltage of the fuel cell to a predetermined voltage,
wherein an intermittent operation in which a power generation command value for the fuel cell is set to zero and a power supply to the load is covered by power supplied from the power storage apparatus is allowed to be performed if certain conditions for performing the intermittent operation are met, and the performance recovery processing is performed during the intermittent operation, and
wherein, if the performance recovery processing is necessary and if a remaining power in the power storage apparatus is equal to or lower than a predetermined amount, the control apparatus delays a timing of performing the intermittent operation and charges the power storage apparatus until the remaining power exceeds the predetermined amount.

2. The fuel cell system according to claim 1,
wherein the control apparatus predicts a timing of an output increase request being made to the fuel cell and determines content of the performance recovery processing based on a result of the prediction.

3. The fuel cell system according to claim 2, which is installed in a fuel cell vehicle as an in-vehicle power supply,
wherein the control apparatus predicts a timing of an output increase request being made to the fuel cell based on a traveling state of the vehicle.

4. The fuel cell system according to claim 2,
wherein a first oxide film which is able to be removed by decreasing the output voltage of the fuel cell to a first film removal voltage and a second oxide film which is able to be removed only after decreasing the output voltage of the fuel cell to a second film removal voltage, which is lower than the first film removal voltage, are present in a mixed stated in an oxide film formed on the catalyst layer during power generation by the fuel cell, and
wherein the control apparatus changes the predetermined voltage to which the output voltage is to be decreased according to the result of the prediction when the performance recovery processing is necessary.

5. The fuel cell system according to claim 2,
wherein a first oxide film which is able to be removed by decreasing the output voltage of the fuel cell to a first film removal voltage and a second oxide film which is able to be removed only after decreasing the output voltage of the fuel cell to a second film removal voltage, which is lower than the first film removal voltage, are present in a mixed stated in an oxide film formed on the catalyst layer during power generation by the fuel cell, and
wherein the control apparatus changes a time period for performing the performance recovery processing according to the result of the prediction when the performance recovery processing is necessary.
